(19) United States
(12) Patent Application Publication
(10) Pub. No.: US 2025/0167576 A1
(43) Pub. Date: May 22, 2025

(54) SYSTEMS AND METHODS FOR OPTIMIZING THE CHARGING AND DISCHARGING OF BATTERIES

(71) Applicant: LG ENERGY SOLUTION, LTD., Seoul (KR)

(72) Inventors: Kiran KUMAR, Westborough, MA (US); Marielle POINTER, Westborough, MA (US)

(21) Appl. No.: 18/955,197

(22) Filed: Nov. 21, 2024

Related U.S. Application Data
(60) Provisional application No. 63/601,639, filed on Nov. 21, 2023.

(51) Int. Cl. H02J 7/00; H02J 3/00

(52) U.S. Cl. CPC H02J 7/0071; H02J 3/008; H02J 2203/10

(57) ABSTRACT

Systems and methods for optimizing charging and discharging of a battery energy storage system (BESS) are disclosed. A pre-defined time period mapped to electricity price forecast data is partitioned into charging windows and discharging windows. A bidding profile may be generated by identifying combinations of charging windows and discharging windows that maximize a revenue value over the pre-defined time period. A power profile for the BESS derived from the bidding profile is generated, and a battery analytics profile derived from the power profile is generated. The battery analytics profile is assessed for compliance with convergence criteria. If the battery analytics profile complies with the convergence criteria, the bidding profile is transmitted to a server of an electricity market operator for approval, otherwise, the bidding profile is adjusted until the resulting battery analytics profile complies with the convergence criteria.

### CROSS-REFERENCE TO RELATED APPLICATION

This application claims priority to and the benefit of U.S. Provisional Application 63/601,639 filed on Nov. 21, 2023, the disclosure of which is incorporated herein by reference.

### TECHNICAL FIELD

The present disclosure relates to managing a battery energy storage system (BESS), and more particularly to optimizing the charging and discharging of a BESS.

### BACKGROUND

BESSs have become a critical component in modern energy management systems. With the increasing integration of renewable electricity sources such as wind and solar, which are inherently intermittent, energy storage solutions are necessary to ensure electrical grid stability and efficient power distribution. BESS technology allows for the storage of excess electricity during periods of low demand and discharge of scarce electricity during high demand, thereby optimizing energy usage (by reducing the curtailment of solar and wind electricity) and reducing reliance on fossil fuel-based power generation such as gas turbines. This capability is particularly valuable as the global transition to cleaner energy sources accelerates, and as intermittent electricity sources gain larger shares of the electricity supply mix.

### SUMMARY

Electricity market price data may be used to generate a power profile for a BESS that maximizes discharging revenue and minimizes charging costs. However, this power profile may not always minimize the costs associated with the degradation of battery cells over time (for example, due to overheating, frequent cycling, or relatively high or relatively low average charge capacity) or operational costs associated with running HVAC systems to cool the battery cells, voltage imbalances between subsystems of the BESS, or faults such as loose connections or damaged cells.

Accordingly, the present disclosure describes a system and method for optimizing charging and discharging of a BESS to maximize electricity market revenue while reducing degradation and operational costs. The present system and method may advantageously increase revenue (e.g., by 5-10%) while decreasing the cost associated with replacing batteries at end of life (EOL).

According to one aspect, the present disclosure is directed to a system for optimizing charging and discharging of a BESS, comprising: a controller comprising one or more processing modules and one or more non-transitory memory storage modules storing computing instructions which when executed by the one or more processing modules is configured to: partition a pre-defined time period mapped to electricity price forecast data into charging windows and discharging windows; generate a bidding profile by identifying combinations of the charging windows and the discharging windows that maximize a revenue value over the pre-defined time period, wherein the revenue value comprises a discharge revenue minus a charge cost, wherein the discharge revenue accumulates over the discharging windows and the charge cost accumulates over the charging windows; generate a power profile for the BESS derived from the bidding profile, wherein the power profile delineates timing, duration, and magnitude of energy flow to and from the BESS in accordance with the charging windows and discharging windows identified in the bidding profile; generate a battery analytics profile derived from the power profile, wherein the battery analytics profile compiles performance metrics associated with the timing, the duration and the magnitude of the energy flow to and from the BESS delineated in the power profile; assess the battery analytics profile for compliance with convergence criteria; and in response to the battery analytics profile complying with the convergence criteria, transmit the bidding profile to a server of an electricity market operator, or in response to the battery analytics profile not complying with the convergence criteria, adjust the bidding profile until the resulting battery analytics profile complies with the convergence criteria and transmit the adjusted bidding profile to the server of the electricity market operator.

In some cases, the controller is further configured to: in response to approval of the bidding profile by the electricity market operator, instruct the BESS to charge and discharge based on the power profile.

In some cases, the battery analytics profile complies with the convergence criteria when the performance metrics conform to the bidding profile and the resulting power profile that maximize net revenue, minimize temperature, and minimize energy throughput.

In some cases, the performance metrics of the battery analytics profile include a state of health (SOH) of the BESS for each time point in an operational lifetime period of the BESS, and the battery analytics profile complies with the convergence criteria when the SOH of the BESS for each time point in the operational lifetime period is maximized.

In some cases, the performance metrics of the battery analytics profile include a maximum temperature of the BESS over the pre-defined time period, and the battery analytics profile complies with the convergence criteria when the maximum temperature of the BESS over the pre-defined time period is minimized.

In some cases, the performance metrics of the battery analytics profile include an average temperature of the BESS over the pre-defined time period, wherein the battery analytics profile complies with the convergence criteria when the average temperature of the BESS over the pre-defined time period is minimized.

In some cases, the performance metrics of the battery analytics profile include an average state of charge (SOC) of the BESS over the pre-defined time period, wherein the battery analytics profile complies with the convergence criteria when the average SOC of the BESS over the pre-defined time period is within a target average SOC range.

In some cases, the performance metrics of the battery analytics profile include a number of charge-discharge cycles of the BESS over the pre-defined time period, wherein the battery analytics profile complies with the convergence criteria when the number of charge-discharge cycles of the BESS over the pre-defined time period is minimized.

In some cases, the performance metrics of the battery analytics profile include an auxiliary energy consumption of the BESS over the pre-defined time period, wherein the battery analytics profile complies with the convergence criteria when the auxiliary energy consumption over the pre-defined time period is minimized.

In some cases, the performance metrics of the battery analytics profile include voltage imbalances between cells of the BESS over the pre-defined time period, wherein the battery analytics profile complies with the convergence criteria when a maintenance sched-ule to correct the voltage imbalances maximizes the revenue value of the bidding profile.

In some cases, the performance metrics of the battery analytics profile include predicted faults in the BESS over the pre-defined time period, wherein the battery analytics profile complies with the convergence criteria when a maintenance schedule to correct the predicted faults maximizes the revenue value of the bidding profile.

In another aspect, the present disclosure is directed to a method for optimizing charging and discharging of a BESS, comprising: partitioning a pre-defined time period mapped to electricity price data into charging windows and discharging windows; generating a bidding profile by identifying combinations of the charging windows and the discharging windows that maximize a revenue value over the pre-defined time period, wherein the revenue value comprises a discharge revenue minus a charge cost, wherein the dis-charge revenue accumulates over the discharging windows and the charge cost accumulates over the charging windows; generating a power profile for the BESS derived from the bidding profile, wherein the power profile delineates timing, duration, and magnitude of energy flow to and from the BESS in accordance with the charging windows and discharging windows identified in the bidding profile; generating a battery analytics profile derived from the power profile, wherein the battery analytics profile compiles performance metrics associated with the timing, the duration and the magnitude of the energy flow to and from the BESS delineated in the power profile; assessing the battery analytics profile for compliance with convergence criteria; and in response to the battery analytics profile complying with the convergence criteria, transmitting the bidding profile to a server of an electricity market operator, or in response to the battery analytics profile not complying with the convergence criteria, adjusting the bidding profile until the resulting battery analytics profile complies with the convergence criteria and transmit the bidding profile to the server of the electricity market operator.

It should be noted that the technical effects obtainable through the present disclosure are not limited to the above-described effects, and other effects that are not mentioned herein will be clearly understood by those skilled in the art from the following descriptions.

### BRIEF DESCRIPTION OF THE DRAWINGS

The accompanying drawings illustrate exemplary aspects of the present disclosure and, together with the following detailed description, serve to provide further understanding of the technical spirit of the present disclosure. However, the present disclosure is not to be construed as being limited to the drawings.

FIG. 1 is a perspective view schematically showing the configuration of a battery container in accordance with an aspect of the present disclosure.

FIG. 2 is a perspective view schematically showing a form in which some components of the battery container are separated or moved in accordance with an aspect of the present disclosure.

FIG. 3 is a diagram showing the internal configuration of the battery container viewed from above in accordance with an aspect of the present disclosure.

FIGS. 4A-4B are schematic diagrams illustrating the implementation of a system and/or method for optimizing the charging and discharging of a BESS in accordance with an aspect of the present disclosure.

FIG. 5 is a graph illustrating the generation of a bidding profile in accordance with an aspect of the present disclosure.

FIG. 6 is a graph illustrating the generation of a power profile in accordance with an aspect of the present disclosure.

FIG. 7 is a graph illustrating an SOC profile extracted from a power profile in accordance with an aspect of the present disclosure.

FIG. 8 is a graph illustrating a temperature profile extracted from a power profile in accordance with an aspect of the present disclosure.

FIG. 9 is a graph illustrating a SOH profile extracted from a power profile in accordance with an aspect of the present disclosure.

FIGS. 10A-10C are conceptual images illustrating a UI dashboard showing LMP data, battery performance profiles, net revenue, and degradation costs in accordance with an aspect of the present disclosure.

### DETAILED DESCRIPTION OF THE DISCLOSURE

The present disclosure may be variously changed and have various aspects, and the specific aspects disclosed herein in detail are used to facilitate an understanding of the present disclosure to those skilled in the art.

Therefore, it should be understood that there is no intention to limit the present disclosure to the particular aspects disclosed, and on the contrary, the present disclosure covers all modifications, equivalents, and alternatives falling within the spirit and scope of the present disclosure.

In this application, it should be understood that terms such as “include” or “have” are intended to indicate the presence of a feature, number, step, operation, component, part, or a combination thereof described on the specification, and they do not preclude the possibility of the presence or addition of one or more other features or numbers, steps, operations, components, parts or combinations thereof.

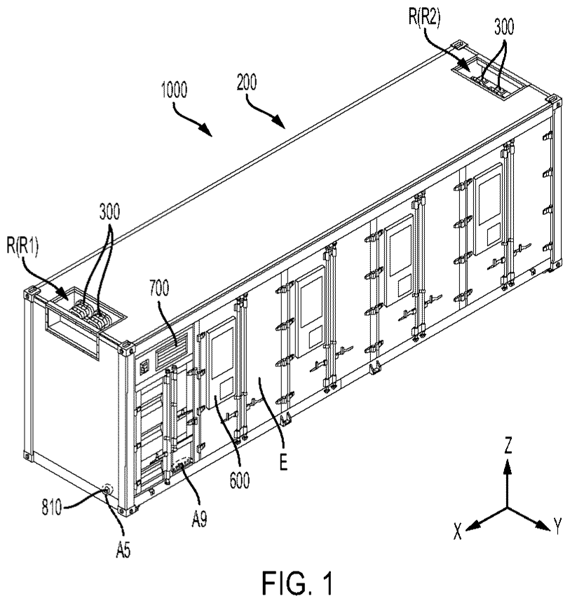

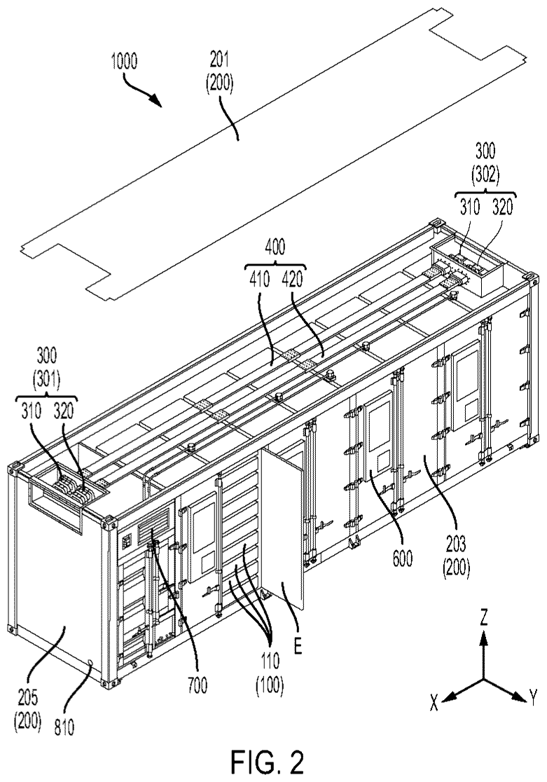

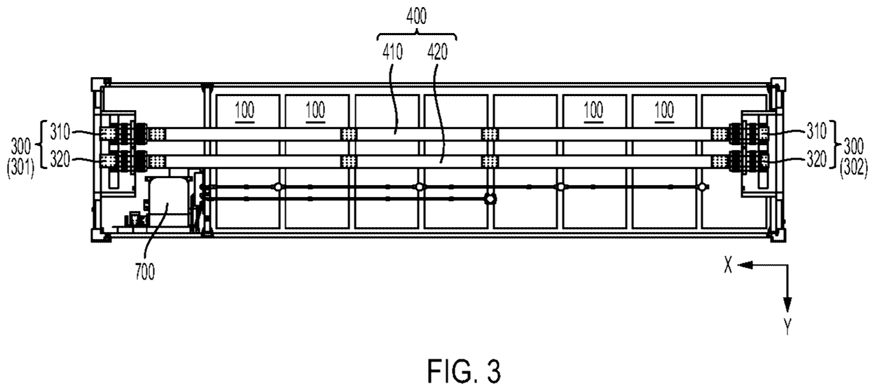

FIG. 1 is a perspective view schematically showing the configuration of a battery container 1000 of a BESS according to an aspect of the present disclosure. Also, FIG. 2 is a perspective view schematically showing a form in which some components of the battery container 1000 are separated or moved according to an aspect of the present disclosure. FIG. 3 is a diagram showing the internal configuration of the battery container 1000 according to an aspect of the present disclosure, viewed from above.

Referring to FIGS. 1 to 3, a battery container 1000 according to the present disclosure includes a battery rack 100, a container housing 200, a main connector 300, and a main bus bar 400.

The battery rack 100 may include a plurality of battery modules 110. Here, each battery module 110 may be configured in a form in which a plurality of battery cells (secondary batteries) are accommodated in a module case. In addition, the battery modules 110 may be stacked in one direction, such as in an upper and lower direction, to form a battery rack 100. In particular, the battery rack 100 may include a rack case to facilitate stacking of the battery modules 110. In this case, a plurality of battery modules 110 may be accommodated in respective storage spaces provided in the rack case to form a module stack. In some aspects, the battery modules 110 may be arranged in other configurations, such as side-by-side or in a matrix pattern. The rack case may include features like cooling channels or structural reinforcements to support the weight of the stacked modules. In some cases, the battery rack 100 may incorporate sensors to monitor temperature, voltage, or other parameters of the battery modules 110.

The battery module 110 included in the battery rack 100 may further include a control unit such as a battery management system (BMS) for each group or certain groups. For example, a separate pack BMS may be provided for each battery module 110. In this case, each battery module 110 may be referred to as a battery pack. That is, it may be regarded that the battery rack 100 includes a plurality of battery packs. In various descriptions below, the battery module 110 may be replaced with a battery pack. In some cases, the battery rack 100 may incorporate sensors to monitor parameters like temperature, voltage, or current of the battery modules 110. The BMS for each battery module or pack may communicate with a higher-level rack BMS to coordinate overall rack performance and safety.

One or more battery racks 100 may be included in the battery container 1000. In particular, a plurality of battery racks 100 may be included in the battery container 1000. Also, the plurality of battery racks 100 may be disposed in at least one direction, for example, in a horizontal direction. For example, eight battery racks 100 may be included in the battery container 1000, and the plurality of battery racks 100 may be arranged in left and right directions (X-axis direction) inside the battery container 1000. When a plurality of battery racks 100 are included, a separate control unit, such as a rack BMS, may be provided for each battery rack 100. In this case, the rack BMS may be connected to the plurality of pack BMSs to exchange data and control the plurality of pack BMSs. Meanwhile, when the battery container 1000 includes at least one rack BMS, the rack BMS may be connected to a separate control device provided outside the battery container 1000, such as a control container. In addition, the control container may be connected to a rack BMS or a pack BMS of the battery container 1000 to control the same or exchange data with the same.

An empty space may be formed inside the container housing 200. Also, the container housing 200 may accommodate the battery rack 100 in the inner space. More specifically, the container housing 200 may be formed in a substantially rectangular parallelepiped shape, as shown in FIG. 1 and the like. In this case, the container housing 200 may include an upper housing 201, a lower housing, a front housing 203, a rear housing, a left housing 205, and a right housing around the inner space. Also, the container housing 200 may accommodate the battery rack 100 in the inner space defined by these six unit housings.

The container housing 200 may be made of a material that secures a certain level of rigidity and stably protects internal components from external physical and chemical factors. For example, the container housing 200 may be made of a metal material, such as steel, aluminum, or titanium, or may have such a metal material. In some aspects, the container housing 200 may be constructed from composite materials like carbon fiber reinforced polymers or fiberglass, which offer high strength-to-weight ratios. The housing may also incorporate corrosion-resistant alloys like stainless steel or galvanized steel in areas exposed to harsh environmental conditions. In some cases, the container housing 200 may utilize a combination of materials, such as a steel frame with aluminum panels, to balance strength, weight, and cost considerations. Additionally, the housing may include specialized coatings or treatments, such as powder coating or anodizing, to enhance durability and weather resistance.

The container housing may have a size identical or similar to the size of a shipping container. In addition, the container housing may follow the standards of a shipping container predetermined according to the ISO standards or the like. For example, the container housing may be designed with identical or similar dimensions as a 20-foot container or a 40-foot container. However, the size of the container housing may be appropriately designed depending on the situation. In particular, the size or shape of the container housing may be set variously according to the construction scale, shape, topography, or the like of a system to which the battery container is applied, such as an energy storage system. The present disclosure may not be limited by to the size or shape of the container housing. In some aspects, for example, the container housing may have other shapes such as cylindrical, spherical, or custom polygonal shapes. The housing may also be modular, allowing for expansion or contraction based on capacity needs. In some cases, the container housing may incorporate features like sloped roofs for water runoff or reinforced walls for increased durability in harsh environments.

The main connector 300 may be configured to be electrically connected to the outside. That is, with respect to the battery container 1000, the main connector 300 may be configured to be connected to another component outside the battery container 1000, for example another battery container 1000 or a control container equipped with a control unit such as a battery system controller (BSC).

The main connector 300 may be located on at least one side of the container housing 200. For example, the main connector 300 may be located on the left or right side of the container housing 200. Moreover, a plurality of main connectors 300 may be included in the battery container 1000. For example, as shown in FIGS. 2 and 3, the main connector 300 may include two main connectors 300, namely a first connector 301 and a second connector 302.

The plurality of main connectors 300 may be located on different sides of the container housing 200. Moreover, the plurality of main connectors 300 may be located on opposite sides of the container housing 200. For example, as shown in FIGS. 1 to 3, the first connector 301 and the second connector 302 may be provided on the left and right sides of the container housing 200, respectively. In some aspects, the main connectors 300 may be located on the roof or floor of the container housing 200. In some cases, the main connectors 300 may be positioned at corners or edges of the container housing 200. The main connectors 300 may also be arranged in various configurations, such as in a staggered pattern or aligned vertically along the sides of the container housing 200. In some implementations, additional main connectors may be included on the front or back sides of the container housing 200 to provide further connection options.

The main bus bar 400 may be configured to transmit power. In particular, the main bus bar 400 may serve as a path through which a charging power and a discharging power for the battery rack 100 included in the corresponding battery container 1000 are transmitted. To this end, the main bus bar 400 may be electrically connected to each terminal of the battery module 110 provided in the battery rack 100. Also, the main bus bar 400 may be connected to the main connector 300. Accordingly, the main bus bar 400 may serve as a path through which a charging power is transferred from the main connector 300 to the battery module 110. In addition, the main bus bar 400 may serve as a path through which a discharging power is transmitted from the battery module 110 to the main connector 300.

Moreover, the main bus bar 400 may function as a power transmission line between the plurality of main connectors 300. To this end, different ends of the main bus bar 400 may be connected to different main connectors 300. For example, the main bus bar 400 may be a power line elongated in one direction, for example in left and right directions. In this case, both ends of the main bus bar 400 may be connected to different main connectors 300, for example the first connector 301 and the second connector 302. Also, the main bus bar 400 may serve as a path for transmitting power between different main connectors 300, for example between the first connector 301 and the second connector 302.

The main bus bar 400 may include two unit bus bars, namely a positive electrode bus bar 410 and a negative electrode bus bar 420, in order to function as a power transmission path. The positive electrode bus bar 410 may be connected to a positive electrode terminal of the battery rack 100 or a positive electrode terminal of the battery module 110 included therein. Also, the negative electrode bus bar 420 may be connected to a negative electrode terminal of the battery rack 100 or a negative electrode terminal of the battery module 110 included therein.

In addition, the main connector 300 may be separately provided at each end of the positive electrode bus bar 410 and the negative electrode bus bar 420. For example, the first connector 301 and the second connector 302 may be provided at the left and right ends of the positive electrode bus bar 410, respectively. The first connector 301 and the second connector 302 provided at both ends of the positive electrode bus bar 410 may be a positive electrode connector 310. Also, the first connector 301 and the second connector 302 may be provided at the left end and the right end of the negative electrode bus bar 420, respectively. The two connectors provided at both ends of the negative electrode bus bar 420, namely the first connector 301 and the second connector 302, may all be negative electrode connectors 320.

In addition, the battery container 1000 according to the present disclosure may include a cable cover CC. The cable cover CC may be configured to surround a cable connected to the battery container 1000. For example, a plurality of power cables may be connected to the terminal bus bar TB to transfer power. In this case, the cable cover CC may be located at one end, for example a lower end, of the terminal cover TC to protect a plurality of power cables connected to the terminal bus bar TB. Alternatively, the battery container 1000 may be connected to a data cable to exchange various data with other external components, such as the control container 2000. In this case, the cable cover CC may be configured to protect data cables or the like connected to the battery container 1000 from the outside.

In particular, the cable cover CC may include a cable tray CC1 and a tray cover CC2. The cable tray CC1 may include a body portion attached to an outer wall of the container housing 200 and a sidewall portion protruding outward from an edge of the body portion. For example, the sidewall portion may be formed to protrude to the left from the front edge and the rear edge of the body portion. The tray cover CC2 may be coupled to the end of the sidewall portion protruding from the body portion of the cable tray CC1 to form an empty space therein together with the body portion and the sidewall portion. In particular, this empty space may be formed in a hollow shape. Accordingly, the cable may extend outward from the battery container 1000 through the empty space of the cable cover CC. In addition, the cable extending to the outside may be connected to other external components, such as the control container 2000 or another battery container 1000.

According to this aspect, by minimizing the exposure of the cable extending from the battery container 1000 to the outside, it is possible to protect the cable and prevent damage or breakage of the cable. Moreover, the cable cover CC is configured to have a hollow formed downward at the side surface of the container housing, so that the cable accommodated inside may be exposed downward to the outside. In this case, it may be advantageous for installation, management, and undergrounding of the cable.

In addition, the battery container 1000 according to the present disclosure may further include an air conditioning module 600 as shown in FIGS. 1 and 2. The air conditioning module 600 may be configured to regulate air inside the container housing 200. In particular, the air conditioning module 600 may control the temperature state of an internal air. Moreover, the air conditioning module 600 may be configured to circulate air inside the container housing 200 to control the temperature of various electronic equipment such as the battery rack 100 or the rack BMS included in the battery container 1000 within a certain range. In particular, the air conditioning module 600 may cool the air inside the container housing 200. For example, the air conditioning module 600 may be configured to absorb heat from the air inside the container housing 200 and discharge the heat to the outside. In addition, the air conditioning module 600 may be configured to remove dust or foreign substances from the air inside the container housing 200.

Representatively, the air conditioning module 600 may include at least one HVAC (Heating, Ventilation, & Air Conditioning). For example, the battery container 1000 according to the present disclosure may include four HVACs. The HVAC may allow air to circulate inside the container housing 200. In this case, the temperature of the battery rack 100 may be lowered, and a temperature difference between the battery racks 100 included in the container housing 200 or between the battery modules 110 may be reduced.

In particular, the container housing 200 may include at least one door, as indicated by E in FIGS. 1 and 2, to facilitate installation, maintenance, or repair of the battery rack 100. For example, the container housing 200 may have eight doors E on the front side. Also, two doors E may be opened and closed as a pair in a casement form. In addition, such a door E may be additionally provided on another part of the container housing 200, for example at the rear surface.

In this way, when the door E is provided to the container housing 200, the HVAC may be installed in the door E of the container housing 200. For example, when two doors E are configured as a pair, the HVAC may be provided to one of the two doors E. In addition, the HVAC, namely the air conditioning module 600, may be configured to penetrate the container housing 200, particularly the door E. In this case, one surface of the air conditioning module 600 may be exposed to the outside of the container housing 200, and the other surface of the air conditioning module 600 may be exposed to the inside of the container housing 200. Accordingly, the inner surface of the air conditioning module 600 may contact the internal air of the container housing 200 to absorb heat, and the outer surface of the air conditioning module 600 may contact the external air of the container housing 200 to discharge heat.

The air conditioning module 600 may be configured to prevent direct contact between internal air and external air. That is, the air conditioning module 600 may be configured to prevent internal air from being discharged to the outside and to prevent external air from being introduced into the inside. Therefore, even if the temperature inside the container housing 200 rises, the air conditioning module 600 may absorb only heat from the internal air and discharge the heat to the outside without directly discharging the internal air to the outside. According to this aspect, even if a fire or toxic gas is generated inside the battery container 1000, it is possible to prevent the fire or toxic gas from being discharged to the outside and causing damage to other devices such as other nearby battery containers 1000 or workers at the outside.

In addition, the battery container 1000 according to the present disclosure may further include a venting module 700 as shown in FIGS. 1 and 2. The venting module 700 may be configured to discharge gas inside the container housing 200 to the outside. In addition, the venting module 700 may introduce an external air of the container housing 200 into the inside. Accordingly, the venting module 700 may function as a ventilation device. That is, the venting module 700 may exchange or circulate gas between the inside and the outside of the container housing 200.

In particular, the venting module 700 may be configured to operate in an abnormal situation, such as when a venting gas or fire is generated in a specific battery module 110. Moreover, the venting module 700 may be configured to discharge gas to the outside when the gas or the like is generated inside the container housing 200 due to a thermal runaway phenomenon or the like of the battery rack 100. Moreover, the venting module 700 may be configured to be in a closed state in a normal state and be switched to an open state in an abnormal state such as a thermal runaway situation. In this case, since the venting module 700 performs active ventilation, the venting module 700 may be referred to as an AVS (Active Ventilation System) or include such a system.

In this case, it is possible to prevent a larger problem such as an explosion from occurring due to an increase in the internal pressure of the battery container 1000. In addition, in this case, by rapidly discharging a combustible gas inside the container housing 200 to the outside, it is possible to lower the possibility of a fire in the battery container 1000 or delay the occurrence of a fire, and the scale of a fire may be reduced.

Meanwhile, in the aspect where both the venting module 700 and the air conditioning module 600 are included, in a normal situation, the venting module 700 may not operate, but the air conditioning module 600 may operate. In this case, in the process of cooling, it is possible to prevent foreign substances or moisture from flowing into the container housing 200 through the venting module 700. According to this aspect, since the air conditioning module 600, the venting module 700, and the like are included in the battery container 1000, just by transporting and installing the battery container 1000, the air conditioning module 600 or the venting module 700 may be transported and installed together. Therefore, on-site installation work for installing the energy storage system may be minimized, and the connection structure may be simplified.

In this aspect, the air conditioning module 600 and/or the venting module 700 may operate under the control of the control container 2000. Alternatively, the air conditioning module 600 and/or the venting module 700 may be controlled by a control unit included in the battery container 1000, such as a rack BMS that controls the charge/discharge operation of each battery rack 100 or another separate control unit.

In addition, the battery container 1000 according to the present disclosure may include at least one sensor and provide sensing information to the rack BMS included in the battery container 1000, another separate control unit, or the control container 2000. For example, a temperature sensor, a smoke sensor, an H₂ sensor, and/or a CO sensor may be included in the battery container 1000. In this case, the operation of the air conditioning module 600 and/or the venting module 700 may be controlled based on the information sensed by these sensors. The battery container 1000 may further include a firefighting connector 810 to a firefighting module (not shown).

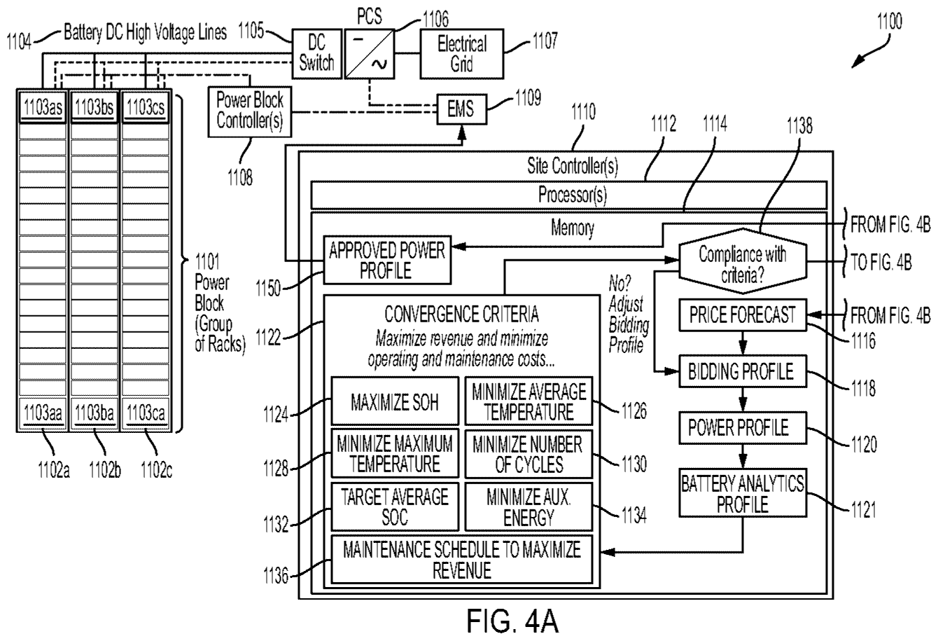

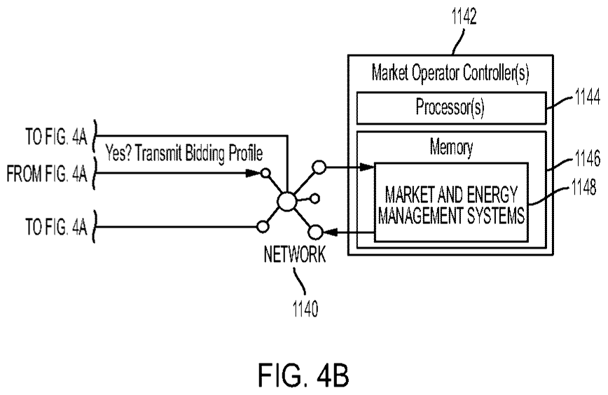

FIGS. 4A-4B are diagrams showing a system 1100 for optimizing the charging and discharging of a BESS, in accordance with an aspect of the present disclosure. The BESS may comprise a power block 1101. The power block 1101 may comprise a plurality of battery racks 1102a, 1102b and 1102c, which in turn respectively comprise a plurality of battery packs 1103aa-as, 1103ba-bs, and 1103ca-cs. The racks 1102a-1102c may comprise physical structures with a standardized form (e.g., a steel or aluminum frame), allowing for easy installation, management, and scalability. A suitable exemplary battery rack may be, for example, the TR1300 (Model ERT5422CN201) manufactured by LG Energy Solution. In some aspects, the racks may be constructed from other materials such as carbon fiber composites, fiberglass, or reinforced plastics to reduce weight while maintaining strength. Each of the battery packs 1103aa-as, 1103ba-bs, and 1103ca-cs may comprise one or more battery modules, and may include monitoring and management electronics such as a battery management system (BMS). Each of the battery modules may comprise a plurality of battery cells connected together, which may be encased and managed as a single unit. The battery cells are the smallest unit of the BESS, where the electrochemical reaction occurs to store and release energy. The cells may have different form factors, such as cylindrical, pouch, or prismatic. In each of the battery racks 1102a-c, the battery packs 1103aa-as, 1103ba-bs and 1103ca-cs may be electrically connected in series with respect to each other, although the present disclosure is not limited thereto. The battery racks 1102a-c may be electrically connected in parallel with respect to each other, although the present disclosure is not limited thereto. The battery racks 1102a-c and battery packs 1103aa-as, 1103ba-bs and 1103ca-cs may be connected in any series or parallel arrangement to achieve a target power output. While battery packs and/or modules are described in this particular aspect, other racks that exclude packs and/or modules are contemplated within the scope of this disclosure. For example, the rack may comprise a plurality of battery cells, without any module.

The battery racks 1102a-c may be electrically connected to an electrical grid 1107 via voltage lines 1104. The DC switch 1105 may be used to disconnect or isolate the battery from other components for maintenance, safety, or in the event of a fault, particularly from the power conversion system (PCS) 1106, BMS (not shown), or grid-tied inverter. In the case of an overvoltage, overcurrent, or other fault in the system, the DC switch 1105 may quickly interrupt the current to prevent damage to the power block 1101 or other components. The PCS 1106 manages the conversion between DC power from the power block 1101 and AC power for use by the electrical grid 1107 (i.e., the load). The PCS 1106 may include both an inverter (DC to AC) and a rectifier (AC to DC), enabling bidirectional energy flow between the power block 1101 and the electrical grid 1107. The PCS 1106 synchronizes the output from the power block 1101 with the voltage, frequency, and phase of the grid 1107, allowing the power block 1101 to smoothly inject electricity into the grid 1107 or absorb electricity from the grid 1107.

The energy management system (EMS) 1109 may coordinate and optimize the overall energy flows in the BESS. The EMS 1109 may handle the strategic decisions of when and how energy should be stored or discharged, and may integrate multiple energy resources (for example, co-located solar and wind electricity connected in a microgrid and/or the grid 1107). The EMS 1109 may decide when the BESS should store or discharge electricity based on load demands, market signals (e.g., electricity prices such as locational marginal prices (LMP)), and the availability of renewable electricity, and may manage the interaction between the power block 1101 and the grid 1107, providing services such as frequency regulation, voltage support, demand response.

The power block controller (PBC) 1108 may control and operate individual components within the BESS, such as the battery packs 1103aa-as, 1103ba-bs and 1103ca-cs and the battery modules and cells therein, and ensures the safe and efficient operation of the BESS at the hardware level. The PBC 1108 may work in conjunction with one or more BMSs to ensure safe operation of the battery cells, preventing overcharging, deep discharging, or temperature issues. In coordination with the EMS 1109, the PBC 1108 may manage the conversion of DC power from the power block 1101 into AC power for the grid 307 and vice versa (coordinating with the EMS to follow power setpoints) and may make adjustments in real time ensure that the power output from the PB 1101 meets the voltage and frequency requirements of the grid 1107. The PBC 1108 may monitor the power block 1101 for faults and execute protective mechanisms in response to issues such as overvoltage, overcurrent, or overheating, for example, in conjunction with the DC switch 1105. The PBC 1108 may be responsible for executing commands from the EMS 1109 at the hardware level.

The system 1100 may further comprise one or more controllers 1110 including one or more processors 1112 and a memory 1114. The controller(s) 1110 may receive electricity price forecast data 1116 (e.g., locational marginal pricing [LMP] data) from an electricity market portal made available by an independent system operator (ISO) or a regional transmission organization (RTO) that manages electricity grids and markets, for example, via a network 1140 from a market operator server 1142 including a processor 1144 and a memory 1146 that executes a market and/or energy management system 1148. The electricity price forecast data 1116 may be associated with the node on the electricity grid 1107 to which the BESS is connected. The electricity price forecast data 1116 may be used to determine the price of electricity at the node, reflecting the cost of delivering electricity, including generation, transmission congestion, and losses. The electricity price forecast data 1116 may be generated in real-time and through day-ahead market calculations (e.g., a forecasted LMP time series). Examples of ISOs/RTOs that publish electricity price forecast data in the United States include: PJM Interconnection (Eastern U.S.), California Independent System Operator (CAISO) (California), Midcontinent Independent System Operator (MISO) (Midwestern U.S.), New York Independent System Operator (NYISO) (New York), Electric Reliability Council of Texas (ERCOT) (Texas), ISO New England (ISO-NE) (New England region), and Southwest Power Pool (SPP) (Central U.S.).

A bidding profile 1118 may be generated by partitioning the time period mapped to the electricity price forecast data 1116 (e.g., a forecasted LMP time series) into charging windows and discharging windows. Extrema (minima and maxima) may be identified in the electricity price forecast data 1116, and the time period mapped may be partitioned into the charging windows corresponding to the minima and the discharging windows corresponding to the maxima, although the present disclosure is not limited thereto, and the electricity price forecast data 1116 may be partitioned in other ways. The bidding profile 1118 may be generated by identifying combinations of charging windows and discharging windows that maximize a revenue value over the pre-defined time period. The revenue value may be a discharge revenue minus a charge cost, where the discharge revenue accumulates over the discharging windows and the charge cost accumulates over the charging windows. It is noted herein that the bidding profile 1118 may be generated in other ways, and the present disclosure is not limited to partitioning a time period associated with electricity price forecast data.

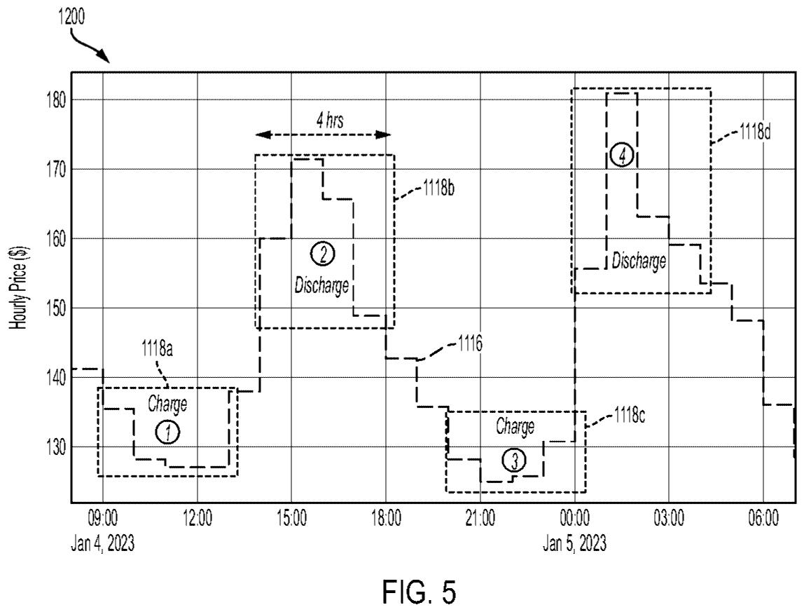

As shown in the graph 1200 of FIG. 5, the electricity price forecast data 1116 may be partitioned into charging windows 1118a and 1118c and discharging windows 1118b and 1118d. When identifying the combinations that maximize the revenue value, a charging window may be followed by a discharging window. For example, the discharging windows 1118b and 1118d are not a valid combination. The revenue may be calculated by multiplying the hourly LMP by the hourly power applied, i.e., Σₜ₌₁^{k}LMPₜ*Powerₜ. For the four-hour windows shown in the graph 1200, if the BESS power is 175 MW, the estimated revenue of the following combinations may be calculated:

Combination #1: 1118a+1118b+1118c+1118d results in $91,300.

Combination #2: 1118a+1118dresults in $67,700.

Combination #3: 1118b+1118c+1118d results in $82,400.

Combination #1 is the combination that maximizes the revenue value, and may therefore be identified (i.e., selected) for the bidding profile 1118.

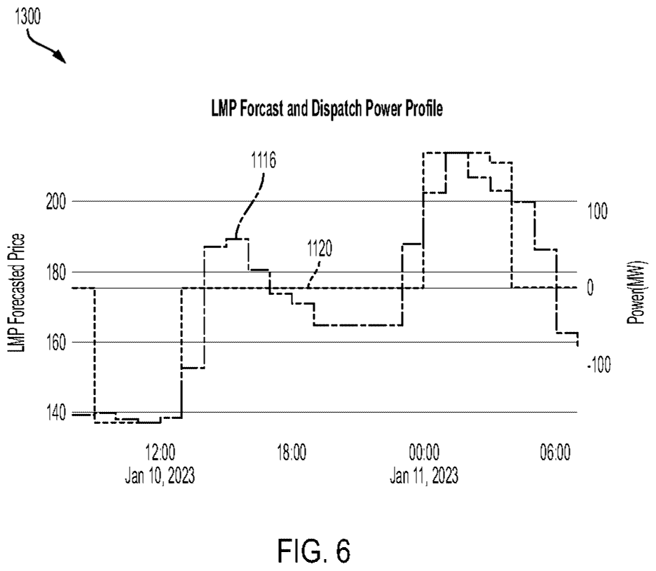

Referring again to FIGS. 4A-4B, a power profile 1120 derived from the bidding profile 1118 may be generated by translating the combinations of charging windows and discharging windows identified in the bidding profile 1118 into actual charging and discharging actions, e.g., as instructions for the EMS 1109 and/or the PB controller 1108. The power profile 1120 may delineate the timing, duration, and magnitude of energy flow to and from the BESS in accordance with the charging windows and discharging windows identified in the bidding profile 1118. The power profile 1120 may account for the BESS's physical constraints, such as maximum charging/discharging rates, state of charge (SOC), and efficiency losses. In some cases, as market conditions change (e.g., clearing prices), the power profile 1120 may be adjusted dynamically to match the combinations that maximize revenue identified in the bidding profile 1118. As shown in the graph 1300 of FIG. 6, in some cases, the power profile 1120 may not track the bidding profile 1118 and electricity price forecast data 1116 exactly or closely, but rather may be generated to ensure that the BESS operates within the capabilities of the BESS.

Referring again to FIGS. 4A-4B, a battery analytics profile 1121 derived from the power profile 1120 may be generated. The battery analytics profile 1121 compiles performance metrics associated with the timing, the duration and the magnitude of the energy flow to and from the BESS delineated in the power profile 1120. The performance metrics extracted from the power profile 1120 may include a maximum temperature (measured in ° C.) of the BESS over the pre-defined time period, an average temperature of the BESS (measured in ° C.) over the pre-defined time period, an average SOC (measured in %) of the BESS over the pre-defined time period, a number of charge-discharge cycles of the BESS over the pre-defined time period, an auxiliary energy consumption of the BESS over the pre-defined time period, voltage imbalances between cells of the BESS over the pre-defined time period, and predicted faults in the BESS over the pre-defined time period. In some cases, the performance metrics further include an SOH of the BESS for each time point in an operational lifetime period of the BESS (e.g., a warranty period).

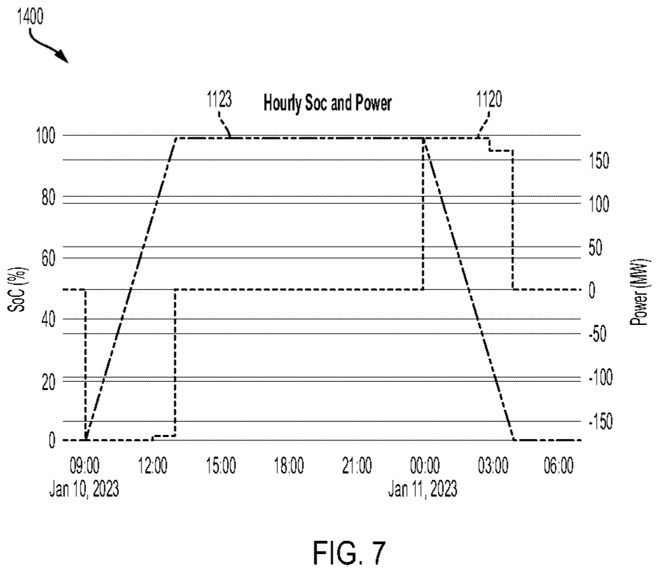

As shown in the graph 1400 of FIG. 7, an SOC profile 1123 may be extracted from the power profile 1120. The SOC profile 1123 may be generated by tracking the SOC at each time point based on the charging and discharging behavior in the power profile 1120. SOC refers to the percentage of a current energy level relative to a total energy capacity, indicating how much charge is remaining, with 100% representing fully charged batteries and 0% indicating completely discharged batteries. The SOC profile 1123 may be used to calculate the average SOC over the pre-defined time period for the battery analytics profile 1121. In general, an average SOC in the range of about 30% to about 70% may result in optimal battery health. The average SOC being too low may indicate deep discharges, which increases stress on the batteries and accelerates capacity degradation over time. The average SOC being too high may also degrade battery health, since the batteries may experience increased stress on their electrodes, which can lead to faster chemical degradation, thermal instability, and capacity loss. High charge levels may also accelerate side reactions, leading to a reduced SOH.

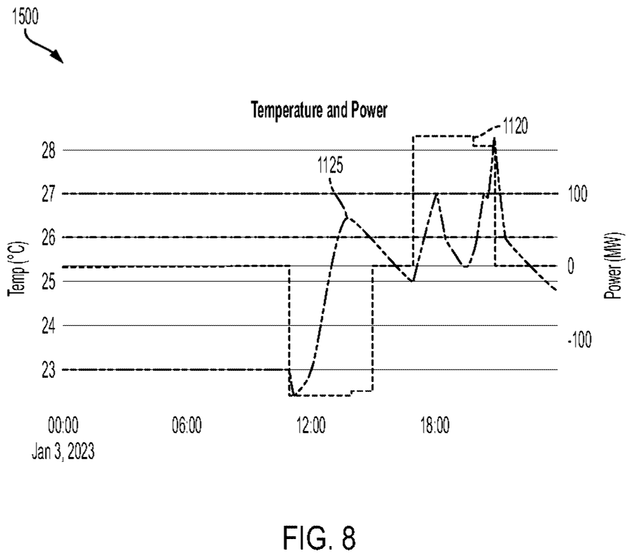

As shown in the graph 1500 of FIG. 8, a temperature profile 1125 may be extracted from the power profile 1120 for the battery analytics profile 1121. The charge/discharge rates of the power profile 1120 may be used to determine the thermal behavior of the BESS over time. The temperature profile 1125 may be generated (i.e., estimated or predicted) from a thermal model, and the maximum temperature and average temperature over the pre-defined time period may be extracted from the temperature profile 1125 for the battery analytics profile 1121. The thermal model may account for the heat generated by the batteries due to charge/discharge cycles, resistance losses (Joule heating), and electrochemical reactions. The thermal model may include heat generation equations, heat dissipation (e.g., air or liquid cooling), and thermal conductivity properties, allowing the thermal model to simulate how the battery's temperature changes under the power profile 1120 and ambient temperatures. Maintaining the average temperature and the maximum temperature of the batteries below a limit by minimizing them is crucial to prevent accelerated degradation of components, which may reduce capacity and lifespan. High temperatures increase the rate of unwanted chemical reactions inside the batteries, leading to capacity loss, safety risks, and potential thermal runaway.

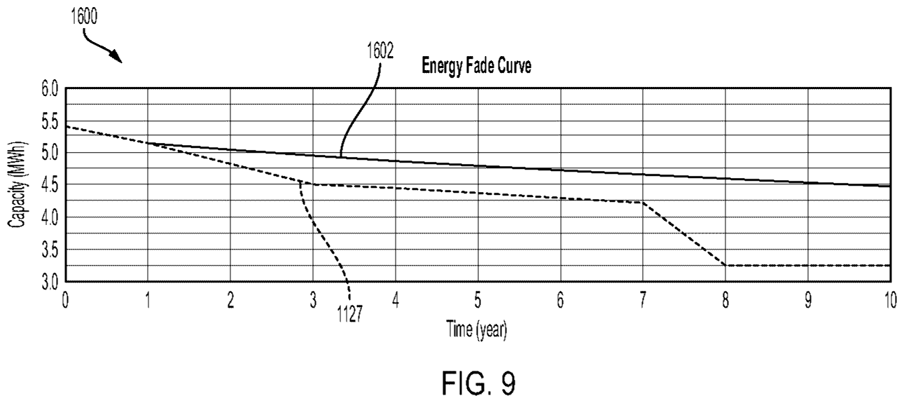

As shown in the graph 1600 of FIG. 9, a SOH profile 1127 may be extracted from the power profile 1120, the SOC profile 1123, the temperature profile 1125, and/or the number of charge-discharge cycles. A reference SOH profile 1602 is shown for comparison. Data from the power profile 1120 (e.g., charge rate data) and the temperature profile 1125 (e.g., average temperature data) may be input into a set of cell degradation equations to generate the SOH profile 1127. The SOH of the BESS for each time point in the operational lifetime period may be extracted from the SOH profile 1127 for the battery analytics profile 1121. SOH refers to the overall condition of a BESS in relation to the BESS's original capacity and performance at beginning of life (BOL), and may be expressed as a percentage, with 100% indicating the battery is in perfect health (e.g., at BOL), and lower values reflecting capacity degradation and reduced ability to hold a charge or deliver power effectively.

To extract the number of charge-discharge cycles from the power profile 1121 for the battery analytics profile 1121, full or partial charge-discharge events may be detected in the power profile 1121 to count the number of cycles the BESS undergoes over the pre-defined time period.

After the battery analytics profile 1121 is generated, the battery analytics profile 1121 may be assessed for compliance with convergence criteria 1122. If the battery analytics profile 1121 does not comply with the convergence criteria 1122 at decision point 1138, the bidding profile 1118 may be adjusted (i.e., optimized) until the resulting power profile 1120 and resulting battery analytics profile 1121 complies with the convergence criteria 1122, thereby generating an adjusted bidding profile 1118. The adjusted bidding profile 1118 may then be transmitted via the network 1140 to the server 1142 of the electricity market operator. If the bidding profile 1118 is approved by the electricity market operator, the BESS may then be charged and discharged based on the power profile 1134, e.g., by instructing the EMS 1109 and/or the PB controller 1108.

In some cases, the battery analytics profile 1121 complies with the convergence criteria 1122 at decision point 1138, and the bidding profile 1118 is not adjusted and is transmitted via the network 1140 to the server 1142 of the electricity market operator for approval.

In some cases, the battery analytics profile 1121 complies with the convergence criteria 1122 when the performance metrics conform to the bidding profile 1118 and the resulting power profile 1120 that maximize net revenue (e.g., by reducing operational and maintenance costs, as well as capital costs related to replacement at EOL), minimize temperature, and minimize energy throughput (e.g., reduce the total amount of energy charged/discharged as well as the number of cycles). For example, the controller 1110 may perform this optimization with mathematical modeling, optimization algorithms, and/or machine learning techniques to achieve the convergence criteria 1122 on the target performance metrics. Objective functions may be defined to quantify the goals (maximizing net revenue, minimizing temperature, and minimizing energy throughput) where each objective function represents one of the target performance metrics. Constraints may be set to represent physical, operational, and market limitations, such as capacity limits, state-of-charge boundaries, operational costs, and environmental conditions (e.g., temperature). The controller 1110 may employ an optimization algorithm (e.g., linear programming, non-linear programming, multi-objective optimization) to explore different configurations of charging, discharging, and resting periods. In some cases, the controller 1110 may employ machine learning models trained on historical data which may, for example, iterate through various power profiles 1120 and bidding profiles 1118 as inputs and generate different battery analytics profiles 1121 as outputs.

In some cases, the battery analytics profile 1121 complies with the convergence criteria 1122 when the SOH of the BESS for each time point in the operational lifetime period is maximized 1124. In some cases, the convergence criteria 1122 includes a target SOH for each time point in the operational lifetime period of the BESS, and the battery analytics profile 1121 complies with the convergence criteria 1122 when the SOH of the BESS for each time point in the operational lifetime period is greater than or equal to the target SOH. In some cases, the target SOH is about 5%, 10%, 15%, 20%, 25%, 30%, 35%, 40%, 45%, 50%, 55%, 60%, 65%, 70%, 75%, 80%, 85%, 90%, or 95%, although the present disclosure is not limited thereto.

In some cases, the battery analytics profile 1121 complies with the convergence criteria 1122 when the maximum temperature of the BESS over the pre-defined time period is minimized 1128. In some cases, the convergence criteria 1122 includes a target maximum temperature over the pre-defined time period, and the battery analytics profile 1121 complies with the convergence criteria 1122 when the maximum temperature of the BESS over the pre-defined time period is less than or equal to the target maximum temperature. In some cases, the target maximum temperature is about 35, 40, 45, 50, 55, 60, 65, 70, 75, or 80° C., although the present disclosure is not limited thereto.

In some cases, the battery analytics profile 1121 complies with the convergence criteria 1122 when the average temperature of the BESS over the pre-defined time period is minimized 1126. In some cases, the convergence criteria 1122 includes a target average temperature, and the battery analytics profile 1121 complies with the convergence criteria 1122 when the average temperature of the BESS over the pre-defined time period is less than or equal to the target average temperature 1126. In some cases, the target average temperature 1126 is about 20, 21, 22, 23, 24, 25, 26, 27, 28, 29, 30, 31, 32, 33, 34 or 35° C., however the present disclosure is not limited thereto.

In some cases, the convergence criteria 1122 includes a target average SOC range 1132, and the battery analytics profile 1121 complies with the convergence criteria 1122 when the average SOC of the BESS over the pre-defined time period is within the target average SOC range 1132. In some cases, the target average SOC range 1132 is about 20% to about 80%, about 30% to about 70%, about 40% to about 60%, or about 45% to about 55%, however the present disclosure is not limited thereto.

In some cases, wherein the battery analytics profile 1121 complies with the convergence criteria 1122 when the number of charge-discharge cycles of the BESS over the pre-defined time period is minimized 1130. In some cases, the convergence criteria 1122 includes a target cycle limit 1130, and the battery analytics profile 1121 complies with the convergence criteria 1122 when the number of charge-discharge cycles of the BESS over the pre-defined time period is less than or equal to the target cycle limit 1130. In some cases, the target cycle limit 1130 is about 1000, 2000, 3000, 4000, 5000, 6000, 7000, 8000, 9000 or 10,000, however the present disclosure is not limited thereto.

In some cases, the battery analytics profile 1121 complies with the convergence criteria 1122 when the auxiliary energy consumption over the pre-defined time period is minimized 1134. Cooling systems (e.g., air cooling systems such as HVAC or liquid cooling systems) may consume auxiliary energy, which may reduce the net revenue of a BESS site. In some cases, the auxiliary energy consumption may be calculated using the temperature profile 1125 derived from the power profile 1120 as described with respect to FIG. 8.

In some cases, the battery analytics profile 1121 complies with the convergence criteria when a maintenance schedule 1136 to correct the voltage imbalances maximizes the revenue value of the bidding profile 1118. Voltage imbalances can arise due to variations in the state of charge (SOC) across battery cells, which may lead to certain cells reaching their voltage limits before others. This imbalance reduces the overall usable capacity of the BESS, as charging must cease once the highest cell voltage is reached, and discharging is limited when the lowest cell voltage threshold is reached. Voltage imbalances reduce the ability to charge and discharge fully because the battery management system may limit operation to protect individual cells from overcharging or deep discharging, which can lead to reduced lifespan or thermal issues. In some cases, the battery analytics profile 1121 complies with the convergence criteria 1122 when a maintenance schedule 1136 to correct the predicted faults maximizes the revenue value of the bidding profile 1118. The predicted faults may include, for example, loose connections, thermal runway, and physical damage (e.g., degradation of electrodes or electrolyte). An example of setting a maintenance schedule to maximize the revenue value of the bidding profile 1118 may involve correcting the voltage imbalances and/or predicted faults of the affected subsystems (e.g., packs or racks) during spring months when revenues are relatively lower, instead of summer months when energy demand (e.g., AC cooling) is at its peak and thus revenues are relatively higher.

Referring again to FIGS. 4A-4B, the controller(s) 1110 may include one or more processor(s) 1112 (i.e., processing modules) configured to execute program instructions maintained on a memory 1604 (i.e., memory module(s)). In this regard, the one or more processors 1112 of controller(s) 1110 may execute any of the various methods, processes, steps, or algorithms described throughout the present disclosure, for example, the generation of the bidding profile 1118 based on the electricity price forecast data 1116, the generation of the power profile 1120 based on the bidding profile 1118, the generation of the battery analytics profile 1121 based on the power profile 1120, the assessment of the battery analytics profile 1121 for compliance with the convergence criteria 1122, and the adjustment or optimization of the bidding profile 1118 based on the compliance of the battery analytics profile 1121 with the convergence criteria 1122.

Further, the controller(s) 1110 may be configured to receive data including, but not limited to the electricity price forecast data 1116 (e.g., from a market operator server 1142 associated with an electricity market). The controller 1110 may provide the adjusted power profile 1134 data to the EMS 1109 and/or the power block controller 1108, which may then make decisions on when to discharge and how much energy to discharge.

The controller(s) 1110 (i.e., computing device) may comprise a desktop computer, mainframe computer system, workstation, image computer, parallel processor, or any other computer system (e.g., networked computer). The one or more processors 1112 of the controller(s) 1110 may include any processing element known in the art. In this sense, the processor(s) 1112 may include any microprocessor-type device configured to execute algorithms and/or instructions, for example, application specific integrated circuit (ASIC), field programmable gate array (FPGA), parallel processor, graphics processing unit (GPU), central processing unit (CPU), other chipsets, a logical circuit, and/or an electronic processor. It is further recognized that the term “processor” may be broadly defined to encompass any device having one or more processing elements, which execute program instructions from a non-transitory memory 1604. Further, the steps described throughout the present disclosure may be performed by a single controller 1110 or, alternatively, multiple controllers 1110. For example, the power block controller 1108, EMS 1109, PCS 1106 and controller 1110 may be the same controller or multiple controllers. Additionally, the controller(s) 1110 may be housed in a common housing or within multiple housings. In this way, any controller or combination of controllers may be separately packaged as a module suitable for integration into BESS subsystem 1300a.

The memory 1604 may include any storage medium known in the art suitable for storing program instructions executable by the associated one or more processors 1602. For example, the memory 1604 may include a non-transitory memory medium. By way of another example, the memory medium 1604 may include, but is not limited to, a read-only memory, a random access memory, a magnetic or optical memory device (e.g., disk), a magnetic tape, a solid state drive, etc. It is further noted that memory 1604 may be housed in a common controller housing with the processor(s) 1602. In some cases, the memory 1604 may be located remotely with respect to the physical location of the processors 1602 and controller 1600. For instance, the one or more processors 1602 of controller 1600 may access a remote memory (e.g., server or cloud), accessible through a network (e.g., internet, intranet and the like).

The systems and/or methods of the present disclosure may be implemented as computer programs stored in the memory 1604. Any of the data, information, metrics, figures, statistics, inputs, outputs, values, variables or parameters described in the present disclosure may be stored in the memory 1604. A computer program (also known as a program, program instructions, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

In some cases, the controller 1110 is further configured to determine a degradation cost of the BESS over the pre-defined time period, and determine a net revenue over the pre-defined time period, where the net revenue is the revenue value (e.g., calculated with the bidding profile 1118) minus the degradation cost (e.g., calculated with the battery performance profile 1121, for example, the SOH for each time point in the pre-defined time period). The degradation cost may be a fade factor multiplied by an installation cost (i.e., capital cost of the BESS) multiplied by a scale factor (e.g., adjusted to match empirically determined real-world conditions). The fade factor may be a fade per unit time (e.g., SOH % fade per day) multiplied by the pre-defined time period (e.g., days under consideration).

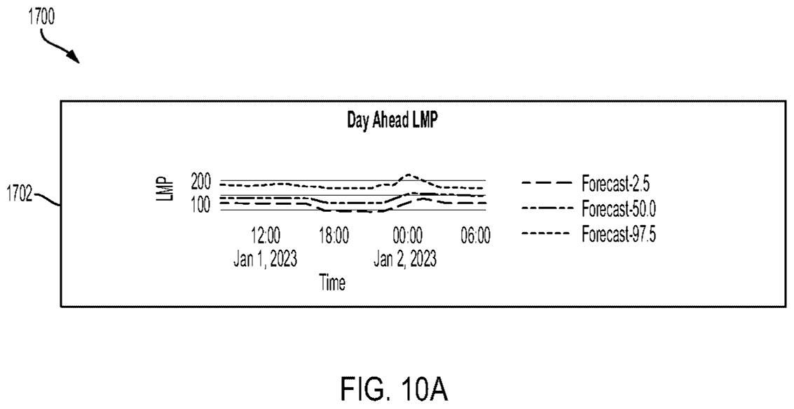

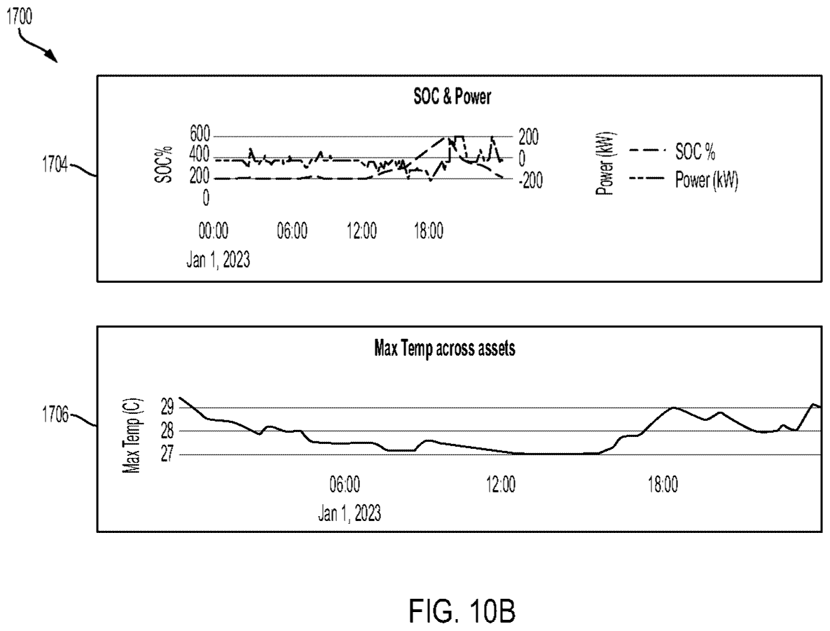

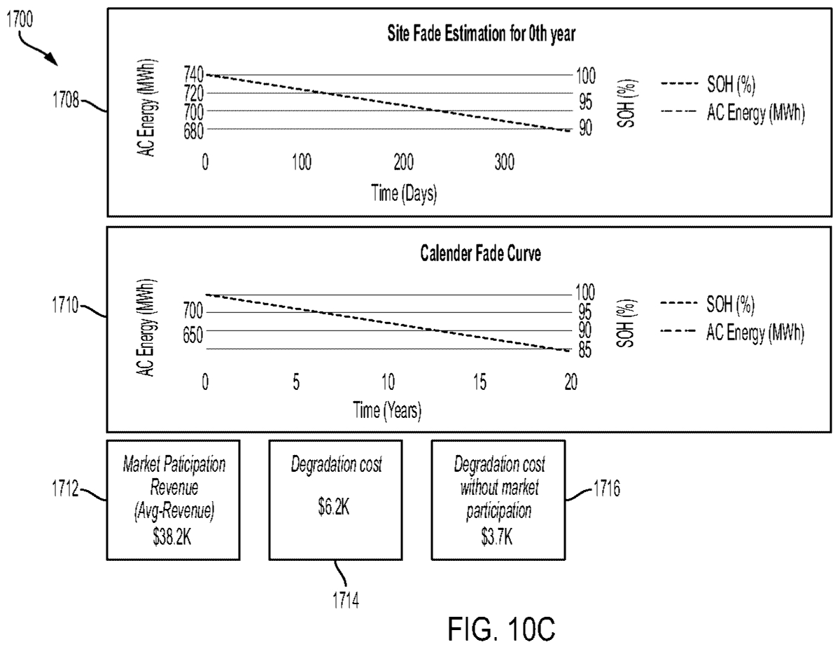

To provide for interaction with a user, embodiments of the subject matter described in this specification (such as the graph 1500) may be displayed on a user interface (UI), such as a display device, e.g., a CRT (cathode ray tube) or LCD (liquid crystal display) monitor, for displaying information to the user and a keyboard and a pointing device, e.g., a mouse or a trackball, by which the user can provide input to the computer. As shown in FIGS. 10A-10C, a UI dashboard 1700 may display electricity price forecast data 1702, SOC and power profile 1704, temperature profile 1706, SOH profile 1708, calendar SOH profile 1710 (e.g., which reflects the degradation of SOH when the BESS is at rest and not charged/discharged), net revenue 1712, degradation cost 1714, and calendar degradation cost 1716 (e.g., which reflects the cost of degradation of SOH when the BESS is at rest and not charged/discharged).

In the above, the present disclosure has been described in more detail through the drawings and aspects. However, the configurations described in the drawings or the aspects in the specification are merely aspects of the present disclosure and do not represent all the technical ideas of the present disclosure. Thus, it is to be understood that there may be various equivalents and variations in place of them at the time of filing the present application which are encompassed by the claims.

1. A system for optimizing charging and discharging of a battery energy storage system (BESS), comprising:
a controller comprising one or more processing modules and one or more non-transitory memory storage modules storing computing instructions which when executed by the one or more processing modules is configured to:
partition a pre-defined time period mapped to electricity price forecast data into charging windows and discharging windows;
generate a bidding profile by identifying combinations of the charging windows and the discharging windows that maximize a revenue value over the pre-defined time period, wherein the revenue value comprises a discharge revenue minus a charge cost, wherein the discharge revenue accumulates over the discharging windows and the charge cost accumulates over the charging windows;
generate a power profile for the BESS derived from the bidding profile, wherein the power profile delineates timing, duration, and magnitude of energy flow to and from the BESS in accordance with the charging windows and discharging windows identified in the bidding profile;
generate a battery analytics profile derived from the power profile, wherein the battery analytics profile compiles performance metrics associated with the timing, the duration and the magnitude of the energy flow to and from the BESS delineated in the power profile;
assess the battery analytics profile for compliance with convergence criteria; and
in response to the battery analytics profile complying with the convergence criteria, transmit the bidding profile to a server of an electricity market operator, or in response to the battery analytics profile not complying with the convergence criteria, adjust the bidding profile until the resulting battery analytics profile complies with the convergence criteria and transmit the adjusted bidding profile to the server of the electricity market operator.

2. The system of claim 1, wherein the controller is further configured to:
in response to approval of the bidding profile by the electricity market operator, instruct the BESS to charge and discharge based on the power profile.

3. The system of claim 1, wherein the battery analytics profile complies with the convergence criteria when the performance metrics conform to the bidding profile and the resulting power profile that maximize net revenue, minimize temperature, and minimize energy throughput.

4. The system of claim 1, wherein the performance metrics of the battery analytics profile include a state of health (SOH) of the BESS for each time point in an operational lifetime period of the BESS, wherein the battery analytics profile complies with the convergence criteria when the SOH of the BESS for each time point in the pre-defined time period is maximized.

5. The system of claim 1, wherein the performance metrics of the battery analytics profile include a maximum temperature of the BESS over the pre-defined time period, wherein the battery analytics profile complies with the convergence criteria when the maximum temperature of the BESS over the pre-defined time period is minimized.

6. The system of claim 1, wherein the performance metrics of the battery analytics profile include an average temperature of the BESS over the pre-defined time period, wherein the battery analytics profile complies with the convergence criteria when the average temperature of the BESS over the pre-defined time period is minimized.

7. The system of claim 1, wherein the performance metrics of the battery analytics profile include an average state of charge (SOC) of the BESS over the pre-defined time period, wherein the battery analytics profile complies with the convergence criteria when the average SOC of the BESS over the pre-defined time period is within a target average SOC range.

8. The system of claim 1, wherein the performance metrics of the battery analytics profile include a number of charge-discharge cycles of the BESS over the pre-defined time period, wherein the battery analytics profile complies with the convergence criteria when the number of charge-discharge cycles of the BESS over the pre-defined time period is minimized.

9. The system of claim 1, wherein the performance metrics of the battery analytics profile include an auxiliary energy consumption of the BESS over the pre-defined time period, wherein the battery analytics profile complies with the convergence criteria when the auxiliary energy consumption over the pre-defined time period is minimized.

10. The system of claim 1, wherein the BESS is configured to store renewable electricity generated by solar power or wind power in order to reduce reliance on fossil fuel-based power generation and mitigate climate change effects.

11. (canceled)

12. A method for optimizing charging and discharging of a battery energy storage system (BESS), comprising:
partitioning a pre-defined time period mapped to electricity price data into charging windows and discharging windows;
generating a bidding profile by identifying combinations of the charging windows and the discharging windows that maximize a revenue value over the pre-defined time period, wherein the revenue value comprises a discharge revenue minus a charge cost, wherein the discharge revenue accumulates over the discharging windows and the charge cost accumulates over the charging windows;
generating a power profile for the BESS derived from the bidding profile, wherein the power profile delineates timing, duration, and magnitude of energy flow to and from the BESS in accordance with the charging windows and discharging windows identified in the bidding profile;
generating a battery analytics profile derived from the power profile, wherein the battery analytics profile compiles performance metrics associated with the timing, the duration and the magnitude of the energy flow to and from the BESS delineated in the power profile;
assessing the battery analytics profile for compliance with convergence criteria; and
in response to the battery analytics profile complying with the convergence criteria, transmitting the bidding profile to a server of an electricity market operator, or in response to the battery analytics profile not complying with the convergence criteria, adjusting the bidding profile until the resulting battery analytics profile complies with the convergence criteria and transmit the bidding profile to the server of the electricity market operator.

13. The method of claim 12, further comprising, in response to approval of the bidding profile by the electricity market operator, instructing the BESS to charge and discharge based on the power profile.

14. The method of claim 12, wherein the battery analytics profile complies with the convergence criteria when the performance metrics conform to the bidding profile and the resulting power profile that maximize net revenue, minimize temperature, and minimize energy throughput.

15. The method of claim 12, wherein the performance metrics of the battery analytics profile include a state of health (SOH) of the BESS for each time point in an operational lifetime period of the BESS, wherein the battery analytics profile complies with the convergence criteria when the SOH of the BESS for each time point in the pre-defined time period is maximized.

16. The method of claim 12, wherein the performance metrics of the battery analytics profile include a maximum temperature of the BESS over the pre-defined time period, wherein the battery analytics profile complies with the convergence criteria when the maximum temperature of the BESS over the pre-defined time period is minimized.

17. The method of claim 12, wherein the performance metrics of the battery analytics profile include an average temperature of the BESS over the pre-defined time period, wherein the battery analytics profile complies with the convergence criteria when the average temperature of the BESS over the pre-defined time period is minimized.

18. The method of claim 12, wherein the performance metrics of the battery analytics profile include an average state of charge (SOC) of the BESS over the pre-defined time period, wherein the battery analytics profile complies with the convergence criteria when the average SOC of the BESS over the pre-defined time period is within a target average SOC range.

19. The method of claim 12, wherein the performance metrics of the battery analytics profile include a number of charge-discharge cycles of the BESS over the pre-defined time period, wherein the battery analytics profile complies with the convergence criteria when the number of charge-discharge cycles of the BESS over the pre-defined time period is minimized.

20. The method of claim 12, wherein the performance metrics of the battery analytics profile include an auxiliary energy consumption of the BESS over the pre-defined time period, wherein the battery analytics profile complies with the convergence criteria when the auxiliary energy consumption over the pre-defined time period is minimized.

21. The method of claim 12, wherein the BESS is configured to store renewable electricity generated by solar power or wind power in order to reduce reliance on fossil fuel-based power generation and mitigate climate change effects.

22. (canceled)
